(19) United States
(12) Patent Application Publication
(10) Pub. No.: US 2014/0074282 A1
(43) Pub. Date: Mar. 13, 2014

(54) MULTIPLEXING SYSTEM FOR A FUEL TRANSACTION ENVIRONMENT

(71) Applicant: PROGRESSIVE INTERNATIONAL ELECTRONICS, INC., Knightdale, NC (US)

(72) Inventor: Arthur E Barker, JR., New Hill, NC (US)

(73) Assignee: PROGRESSIVE INTERNATIONAL ELECTRONICS, INC., Knightdale, NC (US)

(21) Appl. No.: 14/080,927

(22) Filed: Nov. 15, 2013

Related U.S. Application Data
(63) Continuation-in-part of application No. 13/358,689, filed on Jan. 26, 2012.

(51) Int. Cl. B67D 7/14

(52) U.S. Cl. CPC B67D 7/14
USPC 700/232

(57) ABSTRACT

The present invention relates to a system in fuel dispensing control such as gasoline pumps wherein a four wire data system is operated utilizing two wires and a multiplexing system.

This application is a continuation-in-part of U.S. non-provisional application Ser. No. 13/358,689 filed on Jan. 26, 2012 which is included herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to fuel dispensing control. In particular, it relates to methods and devices for controlling a fuel dispenser from a credit card terminal.

2. Description of Related Art

Fuel environment transaction systems have been around for years and now the transaction system is integrated into the fuel dispenser. Traditional gasoline pumps at service stations and minimart type fueling stations have now become point of sale devices with elaborate electronics controlling the sale with user interfaces including use of large displays utilizing touch screen technology. As the purchase has become more elaborate, the devices include more than just the gasoline sale and can include food, car washes, and the like added into the system.

In a typical arrangement, the user pumps their own gasoline at the pump and a gasoline attendant of some kind sits in a booth or inside to monitor the system and handle cash transactions. Typically, the computer or other data controller is similarly situated with a connection made between the pump and the computer operating system. As an example of a system and the flow of information in such a system, one can refer to U.S. Pat. No. 6,116,505, incorporated herein by reference.

In the installation of these devices, the wiring between the pump and computer is placed in the asphalt or cement of the gasoline station and once placed there becomes extremely difficult to change or add to that line. One problem has begun to occur in the market place. At this point there is a manufacturer of these systems that sells a system that utilizes a two wire system utilizing a current loop. The remaining systems available in the marketplace require four wires to accomplish the same connection or require a non-current loop setup. In the event a gasoline station has only installed two wires underground in a current loop, they are faced with either tearing up their driveway to lay new line or being stuck with one company to purchase their system from without the ability to switch to another system.

### BRIEF SUMMARY OF THE INVENTION

The present invention relates to a system for providing connection to a four wire data system at a fueling station which overcomes these problems and more, providing a system and method for utilizing the two wires to generate a multiplexing four wire system at a remote unit.

Accordingly, in one embodiment of the invention there is claimed a fuel transaction system for enabling the purchase of fuel from a location having a fuel dispensing system, a remote station and two underground communication wires positioned between the remote station to the fuel dispensing system in a current loop comprising:
a) an active multiplexing/demultiplexing unit having active power and two data inputs and two data outputs actively connected to the fuel communication system and a two wire output for connection to an end of the two leading wires;
b) a passive multiplexing/demultiplexing unit having a two wire input for connection to an opposite end of the two communication wires and a four wire data output for connection to the remote station comprising a first and second bidirectional current loop connected to the remote station;
c) wherein the active and passive units are actively connected from the two wire output to the two wire input via the two communication wires; and
d) wherein the system is capable of multiplexing/demultiplexing 4 wire data to and from the fuel dispensing system and the 4 data wire remote station via the two communication wires set up as a current loop.

### BRIEF DESCRIPTION OF THE DRAWINGS

FIG. 1 is a view of a fueling location prior to the present invention.

FIG. 2 is a diagram view of the present invention system.

FIG. 3 is a view of a more detailed view of connection between the multiplexing/demultiplexing units.

FIG. 4 is a simplified schematic of an embodiment of the invention between the multiplexing/demultiplexing units.

FIG. 5 is a simplified schematic of the remote station.

FIG. 6 is a local schematic of the active multiplexing/demultiplexing units.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The term “about” means ±10 percent.

The term “essentially” means ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “fuel transaction system” refers to the entire system of selecting, dispensing, and paying for gasoline at a gasoline dispensing location. The system includes, but is not limited to, a “fuel dispensing system” which consists of a fuel dispensing hose for dispensing the fuel to a customer from an underground tank or other fuel storage device. The dispenser may also include payment mechanisms such as a cash acceptor or a credit card reader and/or any other device (for example “speed pass”) for automated processing of the fuel payment. It usually consists of a receipt producing device for providing an accounting receipt to the customer. Other optional services can be provided like the ability of paying for other services such as car washes, food, or anything else sold at the location. Normally, the fuelling station is a four wire system wherein four wires are run underground to a remote station. However, in this embodiment the fuel transaction system is a four wire system but the location has two underground wires set up as a current loop to use to connect to the remote station and provide bi-directional communication.

As used herein there is a “remote station” which provides information about other purchases, connects to credit card processing, control electronics, data processing, and the like and is located at a distance from one or more fuel dispensing systems at a location. In the present invention the remote station is also a four data wire system designed to receive four wire data from one or more fuel dispensers in the fuel dispensing system. Under normal circumstances with only two underground data communication wires set up as a current loop available, the remote station and the fuel dispensing system could not be utilized.

As used herein, the present invention comprises an “active multiplexing/demultiplexing unit” (M/D 1) which has an active power system for transmitting 4 wires of data over a 2 wire current loop, for example, utilizing electric power from the local fuel dispensing system where this unit is positioned or other localized powering system. The M/D 1 takes the four wire data and passes it out to the two wire underground system current loop. It is also capable of demultiplexing the signals received from the remote unit over the two wire underground system. The output of the M/D 1 is connected to one end of the underground communication wires.

At the opposite end of the two underground wires is a “passive multiplexing/demultiplexing unit” (M/D 2) which has a 2 data wire input and a four data wire input/output set of wires communicatively connected to the remote station. The M/D 2 is then capable of demultiplexing the signal from M/D 1 and delivering it to the remote station and taking a signal from the remote station from its four data wires and delivering it multiplexed bay on the underground wires via the underground two wire system.

In the use of the system of the present invention, a customer purchasing fuel can enter information at the fueling dispensing system which then arrives at the M/D 1. The M/D 1 then sends the data over the underground pair of wires to the M/D 2 which demultiplexes the signal and delivers it to the remote station. The reverse process occurs when the remote station delivers data to the dispensing system.

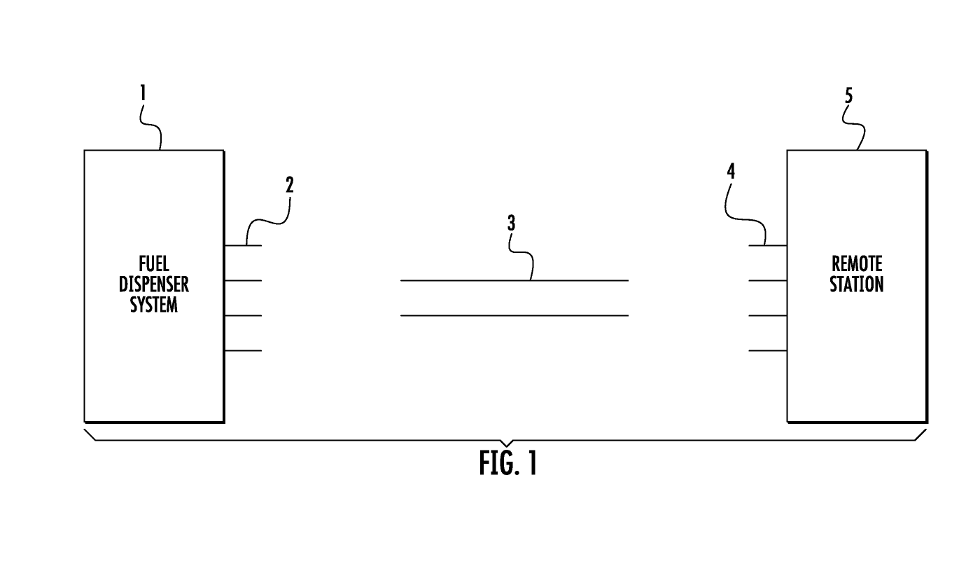

Now referring to the drawings, FIG. 1 shows the basic system setup without the improvement of the present invention. A four data wire fuel dispensing system (1) is shown where fuel is dispensed. A pair of underground wires (3) is shown not connected at either end while four data wire (4) of remote station (5) is shown unconnected.

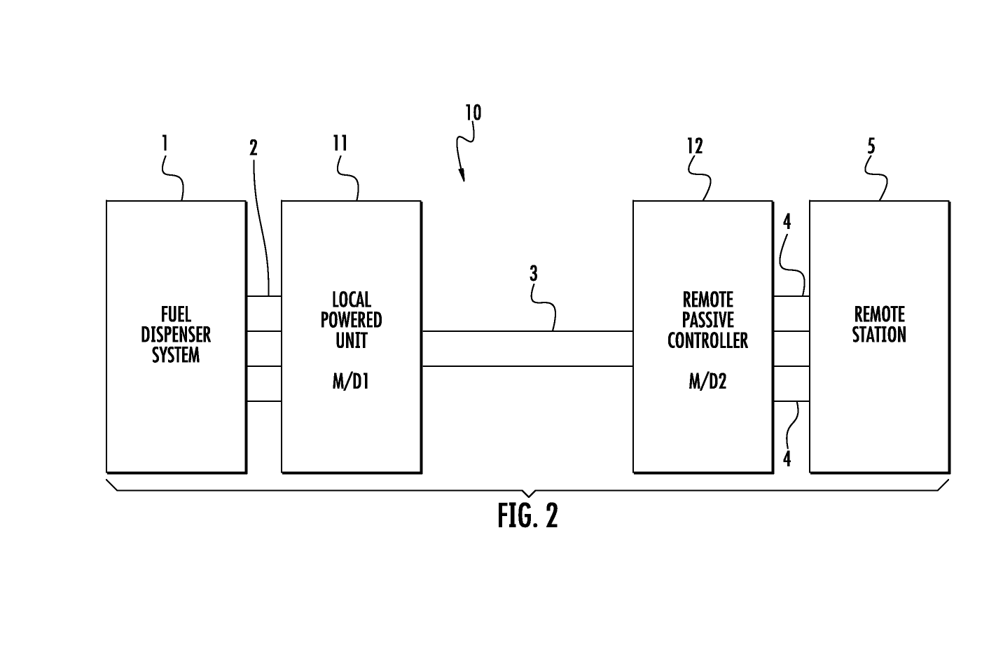

In FIG. 2 the entire system of the present invention is shown. Fuel transaction system 10 is shown with local powered M/D1 (11) shown. The M/D is connected to the data wires of the fuel dispenser (1) and to the underground wires (3). A remote passive controller (12) (non-powered) is hooked up at the other end of underground wires (3) and has a connection to remote station (5) via the four data wires (4).

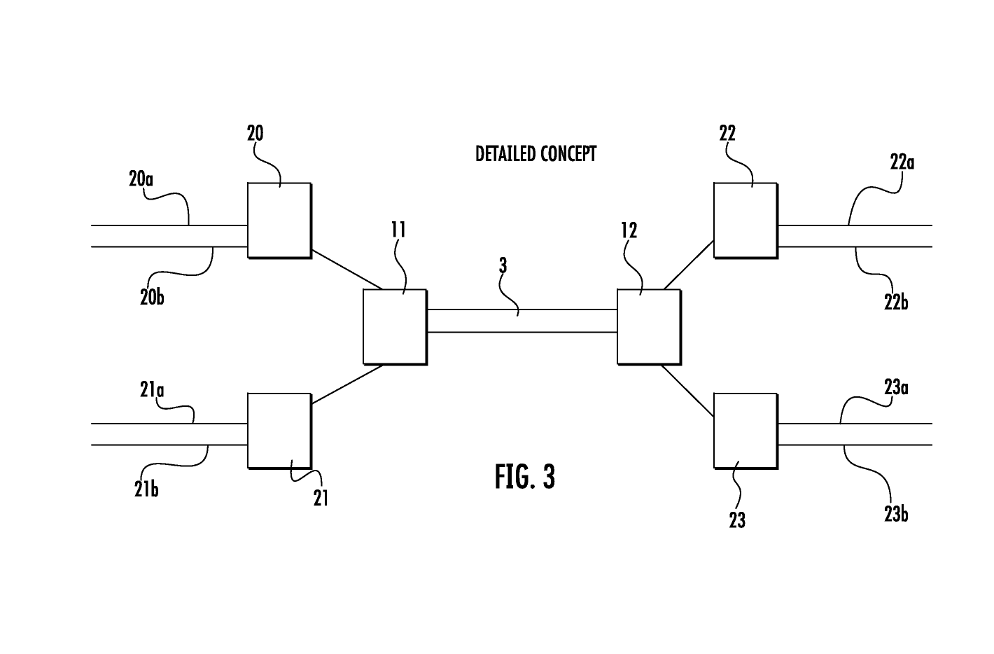

FIG. 3 has a more detailed example of the M/D connection and devices. Devices (20) and (21) represent the two channels (four wires) of M/D (11). The M/D 11 has channel (20) input block wires (20a) (output) and (20b) (input) and channel (21) consisting of wires (21a) (output) and wires (21b) (input) and input. The M/D (11) then alternatively transmits information data from the two channels (20 and 21) via the underground wire pair (3). Transmitting it to M/D2 (12) which demultiplexes the signal and converts it to channel (22) having wires for a bidirectional current loop on wires (22a and 22b). It creates second channel (23) with wires for a bidirectional current loop (23a and 23b) for connection to the remote station.

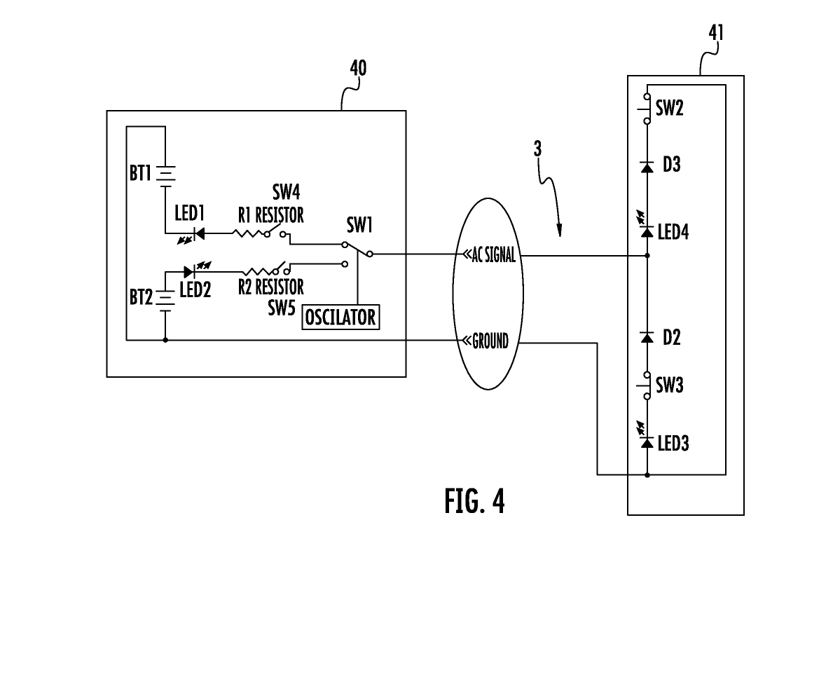

FIG. 4 is an example circuit diagram for the local (11) and remote multiplexer (12). Shown is the local circuit (40) and remote circuit (41) of the present invention. The local circuit receives signals from the fuel dispensing and handles as follows. The following abbreviations are used. BT=battery, LED=Light emitting diode; R=resistor; SW=switch; D=diode; Q=transistor. When SW1 is in the upper position, current flows from BT1 through the ground wire through LED3, SW3, D2, through the AC signal wire (of pair 3), through resistor R1 and LED1 back to the battery. Both LED1 and LED3 will be lit. Pressing SW3 or SW4 will open the circuit, causing LED1 and LED3 to both go out. The resister R1 is utilized to limit the LED current appropriately.

When SW1 is in the lower position, current flows from BT2 through LED2 and R2, switch SW5, and out the AC signal wire, through LED4, D3, SW2, through the ground back to BT1. Both the LED2 and LED4 will be lit. Pressing on SW2 or SW5 will open the circuit causing both LED2 and LED4 to go out. Once again, a resistor R2 limits the current to the LED.

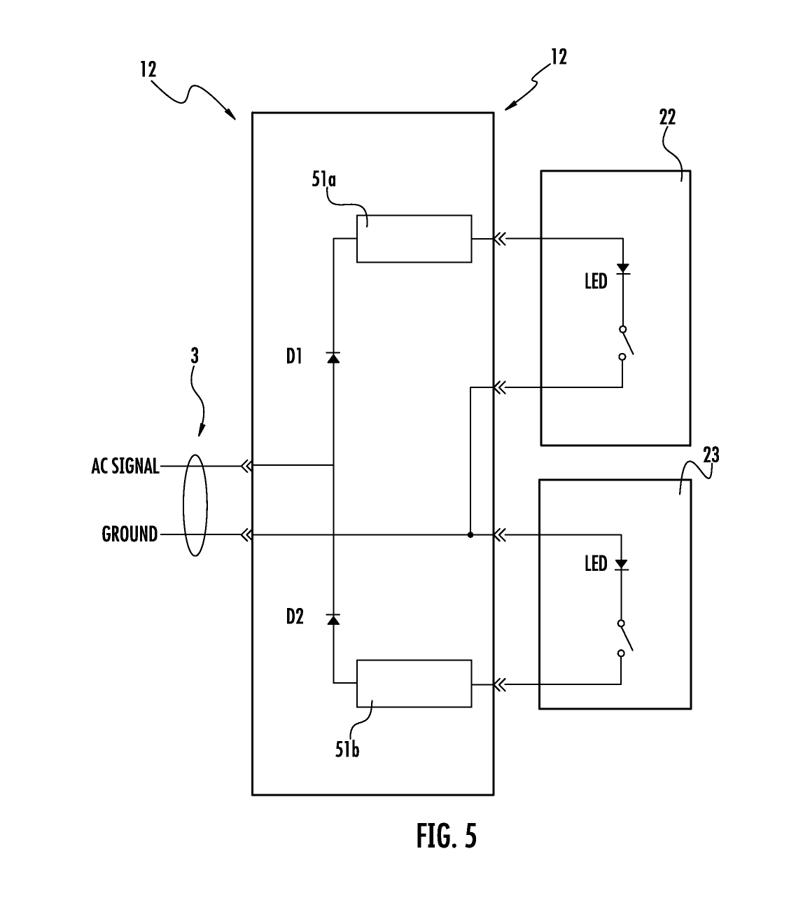

FIG. 5 depicts a simplified but more specific embodiment of the remote passive multiplexer. In the particular example shown, actual circuits are 45 milliamps. Diode D1 allows current flow through the top loop on the positive excursion of the AC signal. Diode D2 allows current to pass through the bottom loop on the negative excursion of the AC signal line. Passive filters (51 a & b) out the high speed carrier signal.

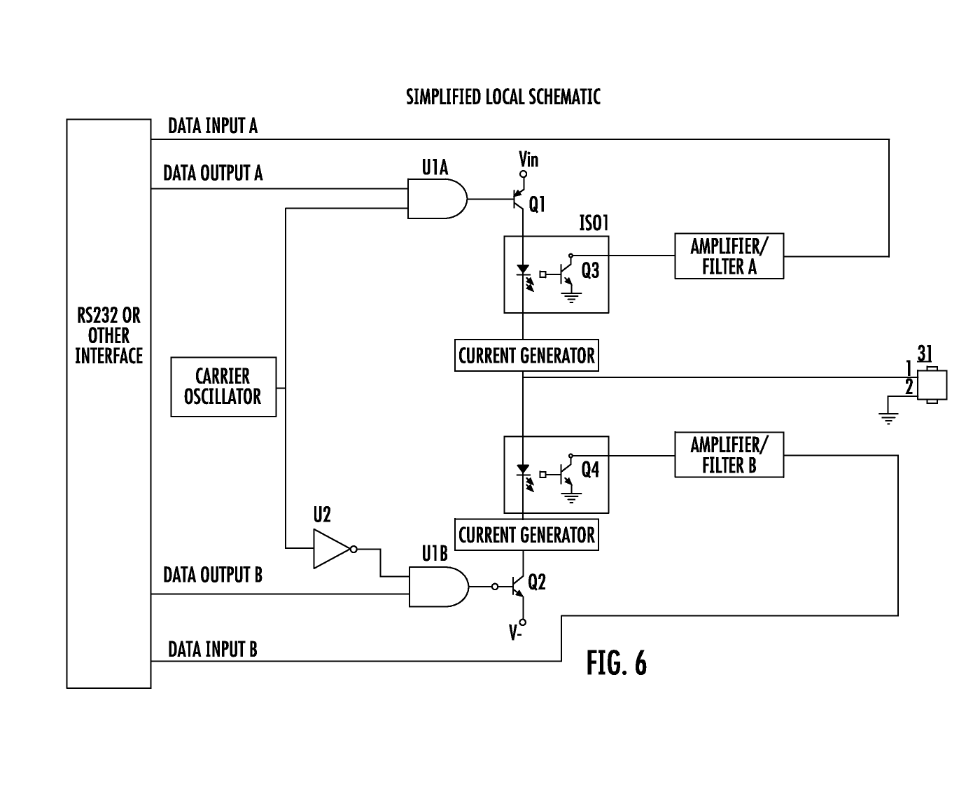

In FIG. 6 shows a simplified schematic that is depicted of the local multiplex unit (M/D1). The local circuit consists of two asynchronous serial channels, using RS-232 or other interface to the pump controller, and circuitry to generate an AC signal, and pick up and filter the receive signal. Carrier oscillator generates a clock at higher speed than the data. This clock performs the flipping of the switch (SW1 on FIG. 4) back and forth at high speeds. The transmission from both the card and clock are synchronized to the carrier oscillator.

Since the top and bottom half of the circuits are essentially identical, only the top half will be described. When the clock is positive, the top half of the circuit is turned on, when the clock is negative, the bottom half of the circuit is turned on, generating the AC signal. The data output A is logically AND'd with the clock, using U1A and U1B generating either the original clock or, nothing, shutting off the positive side of the circuit. Transistor Q1, takes the signal and amplifies it to a higher voltage. ISO1 is an optocoupler used to pick up the receive signal. This circuitry generates the positive side of the AC signal. The bottom half does the same thing, only generating a negative going signal. Depending on the state of the carrier oscillator, only either the top or the bottom half of the circuit is turned on.

The transistor of ISO1 Q3 picks up the signal, and is shaped using AMP/filter A square up the signal. The only differences for the bottom half is the extra inverter U2 so both sides are not on at the same time, and transistor Q2 amplifies to a higher voltage.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A fuel transaction system for enabling the purchase of fuel from a location having a fuel dispensing system, a remote station and two underground communication wires positioned between the remote station to the fuel dispensing system in a current loop comprising:
a) an active multiplexing/demultiplexing unit having active power and two data inputs and two data outputs actively connected to the fuel communication system and a two wire output for connection to an end of the two leading wires;
b) a passive multiplexing/demultiplexing unit having a two wire input for connection to an opposite end of the two communication wires and a four wire data output for connection to the remote station comprising a first and second bidirectional current loop connected to the remote station;
c) wherein the active and passive units are actively connected from the two wire output to the two wire input via the two communication wires; and
d) wherein the system is capable of multiplexing/demultiplexing 4 wire data to and from the fuel dispensing system and the 4 data wire remote station via the two communication wires set up as a current loop.

2. The transaction system according to claim 1 wherein a customer at the fuel dispensing system enters information thereon which is transmitted to the remote station.

3. The transaction system according to claim 1 wherein the fuel dispensing system comprises a customer input device.

4. The transaction system according to claim 1 which includes one or more automated payment mechanisms.

5. The transaction system according to claim 4 wherein the fuel dispensing system includes a credit card reader.

6. The transaction system according to claim 1 wherein there is a central controller communicatively linked to the remote terminal and the fuel dispensing system.

7. The transaction system according to claim 1 wherein the fuel system further comprises purchases other than fuel.

8. The transaction system according to claim 1 wherein there is a computer interface connected to the active multiplexing/demultiplexing unit.
